(19) United States
(12) Patent Application Publication
(10) Pub. No.: US 2013/0321747 A1
(43) Pub. Date: Dec. 5, 2013

(54) LIQUID CRYSTAL DISPLAY DEVICE

(71) Applicants: Masatoshi Kondo, Osaka-shi (JP); Akira Shibazaki, Osaka-shi (JP); Ken Kuboki, Osaka-shi (JP); Satomi Hasegawa, Osaka-shi (JP); Seiji Tanuma, Osaka-shi (JP)

(72) Inventors: Masatoshi Kondo, Osaka-shi (JP); Akira Shibazaki, Osaka-shi (JP); Ken Kuboki, Osaka-shi (JP); Satomi Hasegawa, Osaka-shi (JP); Seiji Tanuma, Osaka-shi (JP)

(73) Assignee: SHARP KABUSHIKI KAISHA, Osaka-shi, Osaka (JP)

(21) Appl. No.: 13/985,026

(22) PCT Filed: Feb. 10, 2012
(86) PCT No.: PCT/JP2012/053117

§ 371 Date: Aug. 12, 2013

(30) Foreign Application Priority Data
Feb. 15, 2011 (JP) 2011-029749

(51) Int. Cl. G02F 1/1343

(52) U.S. Cl. CPC G02F 1/13439
USPC 349/96

(57) ABSTRACT

A liquid crystal display device includes a liquid crystal layer extending in a display region; and a TFT substrate and a counter substrate affixed to each other so as to sandwich the liquid crystal layer therebetween. The TFT substrate is provided with a pixel electrode corresponding to each of a plurality of pixels. The counter substrate is provided with a counter electrode. A first alignment film is disposed on the surface of the pixel electrode that faces the liquid crystal layer. A second alignment film is disposed on the surface of the counter electrode that faces the liquid crystal layer. The pixels each include a plurality of domains having different combinations of alignment directions of the first and second alignment films. A slit is provided in the counter electrode at least in a part of a region corresponding to a boundary between the pixels adjacent to each other.

### TECHNICAL FIELD

The present invention relates to a liquid crystal display device, and particularly to a liquid crystal display device in which a plurality of domains are formed in one pixel.

### BACKGROUND ART

Various types of liquid crystal display devices have been conventionally proposed. Particularly recently, there have been proposed various types of liquid crystal display devices aiming at a widened viewing angle, suppressed disclination, reduced burn-in, and the like. For the purpose of widening a viewing angle, an MVA (Multidomain Vertical Alignment) scheme for forming a plurality of domains in one pixel is proposed.

For example, Japanese Patent Laying-Open No. 2007-249243 (PTD 1) discloses an example of a liquid crystal display device in an MVA scheme. The liquid crystal display device in the MVA scheme disclosed in PTD 1 includes a pair of substrates, a plurality of domains formed in one pixel, and domain limitation means for limiting the tilting direction of the liquid crystal molecule in each domain. As domain limitation means, PTD 1 discloses a protrusion and a depression formed on the surface of the substrate, and an electrode formed in the shape of a fishbone and provided in the substrate.

Such domain limitation means is provided, so that the domains are different from each other in terms of the direction in which liquid crystal molecules are tilted in each domain during voltage application. The liquid crystal molecules are tilted in different directions in different domains in this way, thereby allowing improvement in a viewing angle.

The liquid crystal display device disclosed in Japanese Patent Laying-Open No. 2008-197691 (PTD 2) includes a domain formed in one pixel, and a vertical alignment film provided in a portion in contact with a liquid crystal layer. The vertical alignment film is irradiated with ultraviolet (UV) light from the oblique direction, and thereby, subjected to an alignment process. The irradiation direction of UV light is changed depending on positions, which leads to formation of a plurality of domains. This liquid crystal display device includes a structure having a protruded shape such that liquid crystal molecules are oriented in the orientation limiting direction in each domain during voltage application.

### CITATION LIST

### Patent Document

PTD 1: Japanese Patent Laying-Open No. 2007-249243
PTD 2: Japanese Patent Laying-Open No. 2008-197691

### SUMMARY OF INVENTION

### Technical Problem

In the liquid crystal display device including a plurality of domains in which liquid crystal molecules are oriented in different directions during voltage application, a dark line appears near a part of the boundary between pixels.

Accordingly, an object of the present invention is to provide a liquid crystal display device including a plurality of domains and allowing a reduced width of the dark line appearing near a part of the boundary between pixels.

### Solution to Problem

In order to achieve the above-described object, the liquid crystal display device based on the present invention having a display region including a plurality of pixels includes a liquid crystal layer extending at least in the display region; first and second substrates affixed to each other so as to sandwich the liquid crystal layer; and a pair of polarization plates disposed so as to sandwich the first and second substrates. The first substrate is provided with a pixel electrode corresponding to each of the plurality of pixels. The second substrate is provided with a counter electrode so as to face the pixel electrode. A first alignment film is disposed on a surface of the pixel electrode that faces the liquid crystal layer. A second alignment film is disposed on a surface of the counter electrode that faces the liquid crystal layer. The pixels each include a plurality of domains having different combinations of alignment directions of the first and second alignment films. A slit is provided in the counter electrode at least in a part of a region corresponding to a boundary between pixels adjacent to each other among the plurality of pixels.

### Advantageous Effects of Invention

According to the present invention, a slit is provided in the counter electrode, thereby allowing reduction in the width of a dark line appearing near a part of the boundary between the pixels.

### BRIEF DESCRIPTION OF DRAWINGS

FIG. 1 is a plan view of a pixel electrode.

FIG. 2 is an explanatory diagram of exposure setting on a TFT substrate.

FIG. 3 is an explanatory diagram of exposure setting on a counter substrate.

FIG. 4 is an explanatory diagram showing the state of viewing the posture of a liquid crystal molecule on the TFT substrate.

FIG. 5 shows a symbol indicating a tilt direction of the liquid crystal molecule.

FIG. 6 is an explanatory diagram of the alignment direction set on the TFT substrate.

FIG. 7 is an explanatory diagram of the alignment direction set on the counter substrate.

FIG. 8 is an explanatory diagram of a plurality of domains produced in an area obtained by affixing the TFT substrate and the counter substrate.

FIG. 9 is an explanatory diagram showing the state of viewing the posture of the liquid crystal molecule in the area obtained by affixing the TFT substrate and the counter substrate.

FIG. 10 is the first explanatory diagram showing the tilt direction of the liquid crystal molecule in the center area in the thickness direction within each domain.

FIG. 11 is the secondary explanatory diagram showing the tilt direction of the liquid crystal molecule in the center area in the thickness direction within each domain.

FIG. 12 is an explanatory diagram showing the state where a dark line appears in one pixel.

FIG. 13 shows a simulation result of the transmissive state in one pixel.

FIG. 14 is an explanatory diagram obtained by overlapping a symbol indicating the liquid crystal molecule in one pixel and the simulation result of the transmissive state.

FIG. 15 shows a simulation result of the behavior of each liquid crystal molecule in the liquid crystal layer.

FIG. 16 is a diagram showing a simplified version of the simulation result shown in FIG. 15.

FIG. 17 shows a simulation result of the transmissive state near the boundary between pixels.

FIG. 18 is a perspective view of a liquid crystal display device according to the first embodiment based on the present invention.

FIG. 19 is a fragmentary cross-sectional view of the liquid crystal display device according to the first embodiment based on the present invention.

FIG. 20 is a partial plan view of the liquid crystal display device according to the first embodiment based on the present invention.

FIG. 21 shows a behavior of each liquid crystal molecule and a simulation result of the transmittance in the liquid crystal layer of the liquid crystal display device according to the first embodiment based on the present invention.

FIG. 22 is a diagram showing a simplified version of the simulation result shown in FIG. 21.

FIG. 23 shows a simulation result about appearance of a dark line near the boundary between the pixels of the liquid crystal display device according to the first embodiment based on the present invention.

FIG. 24 is a plan view of the pixel assumed as a premise for the simulation of the transmissive state.

FIG. 25 is a plan view of pixels shown in FIG. 24 that are arranged side by side.

FIG. 26 is an enlarged view of a portion B in FIG. 25.

FIG. 27 shows a simulation result about the behavior of each liquid crystal molecule in Example 1 based on the present invention.

FIG. 28 shows a simulation result about the transmissive state in Example 1 based on the present invention.

FIG. 29 shows a simulation result about the behavior of each liquid crystal molecule in Example 2 based on the present invention.

FIG. 30 shows a simulation result about the transmissive state in Example 2 based on the present invention.

FIG. 31 shows a simulation result about the behavior of each liquid crystal molecule in Example 3 based on the present invention.

FIG. 32 shows a simulation result about the transmissive state in Example 3 based on the present invention.

FIG. 33 shows a simulation result about the behavior of each liquid crystal molecule in Example 4 based on the present invention.

FIG. 34 shows a simulation result about the transmissive state in Example 4 based on the present invention.

FIG. 35 shows a simulation result about the behavior of each liquid crystal molecule in Example 5 based on the present invention.

FIG. 36 shows a simulation result about the transmissive state in Example 5 based on the present invention.

FIG. 37 is a graph showing transmittance curves in a Comparative Example and Examples 2 to 5 that are superimposed on one another.

FIG. 38 is a graph showing a change of the overall transmittance obtained when changing a slit width W in Examples 1 to 5.

FIG. 39 is a plan view of the first example of a counter electrode included in the liquid crystal display device according to the first embodiment based on the present invention.

FIG. 40 is a plan view of the second example of the counter electrode included in the liquid crystal display device according to the first embodiment based on the present invention.

### DESCRIPTION OF EMBODIMENTS

First described will be the reason why the above-mentioned dark line appears.

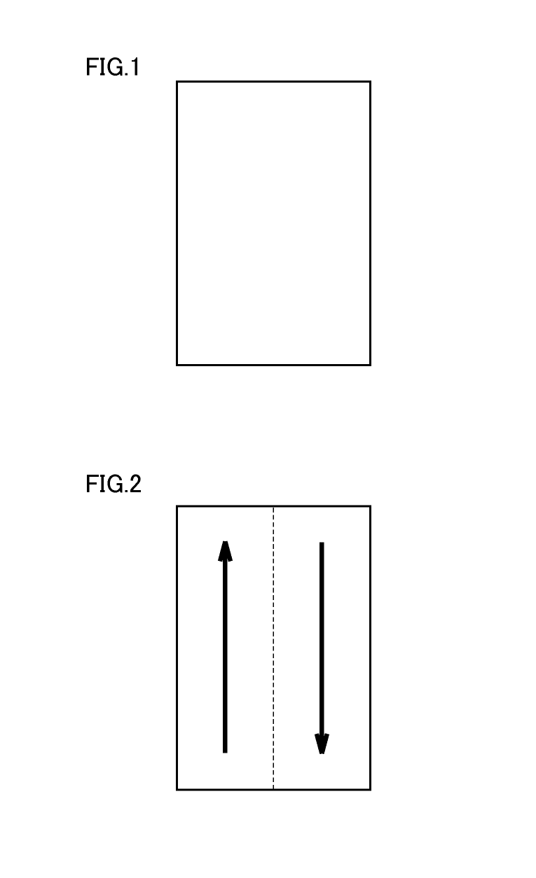

In the liquid crystal display device having a plurality of domains, the posture of a liquid crystal molecule is set for each domain. The substrates sandwiching the liquid crystal layer will be referred to as a TFT (Thin Film Transistor) substrate and a counter substrate. The counter substrate may include a color filter. On the surface of the TFT substrate facing the liquid crystal layer, a pixel electrode having a shape shown in FIG. 1 is provided. The TFT substrate and the counter substrate each have an alignment film provided on their surfaces that are in contact with the liquid crystal layer. In the TFT substrate, the pixel electrode is covered by the alignment film. Referring to each domain, the TFT substrate and the counter substrate are provided on their surfaces with alignment films that are set in different alignment directions. Among the liquid crystal molecules within each domain, the liquid crystal molecules located near each alignment film of the TFT substrate and the counter substrate are tilted in accordance with the alignment direction of the corresponding alignment film.

In addition, the angle formed by the longitudinal direction of the liquid crystal molecule and the substrate surface will be referred to as a “tilt angle”. The direction in which the liquid crystal molecule is tilted as seen from the direction perpendicular to the substrate will be referred to as a “tilt direction.” The tilt angle and the tilt direction in the state where the pixel electrode is not applied with a voltage will be referred to as a “pre-tilt angle” and a “pre-tilt direction”, respectively.

As the distance from the alignment film is increased in the thickness direction of the liquid crystal layer, the posture of each liquid crystal molecule is less influenced by the alignment film. Particularly when the alignment direction of the alignment film of the TFT substrate is different from the alignment direction of the alignment film of the counter substrate, the tilt direction of the liquid crystal molecule is to change along the thickness direction. In the center area of the liquid crystal layer in the thickness direction, the liquid crystal molecule is tilted in the tilt direction that corresponds to an average direction of the tilt direction determined by the alignment film of the TFT substrate and the tilt direction determined by the alignment film of the counter substrate.

On the other hand, near the outline of the pixel, each liquid crystal molecule tends to be tilted in the direction perpendicular to the outline of the pixel and in the direction inwardly of this outline due to the influence of the oblique electric field caused by the end of the pixel electrode.

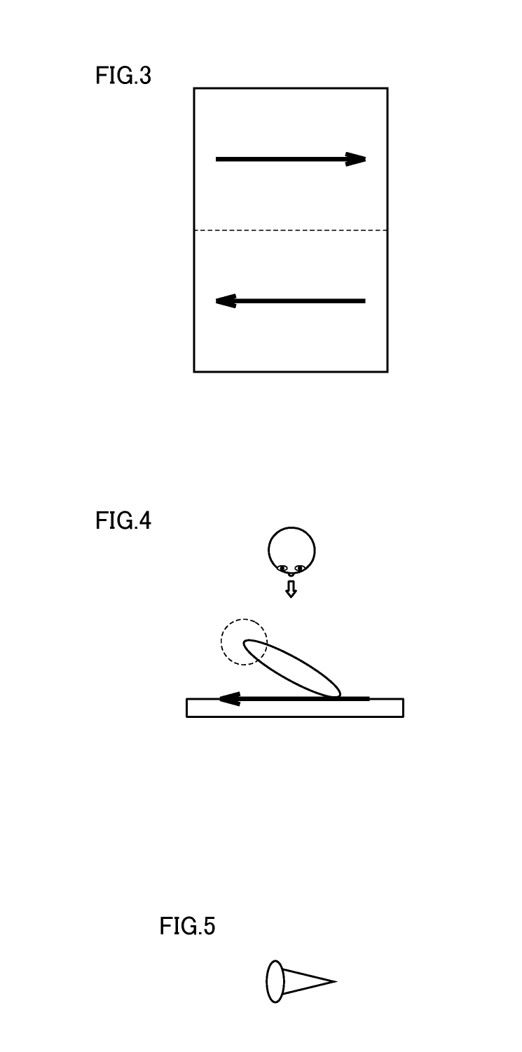

A further detailed explanation will be given about an example as to how the tilt direction of the liquid crystal molecule in each pixel is determined. In each pixel, a pixel electrode having a shape shown in FIG. 1 is provided on the TFT substrate side. Although many pixels are actually arranged on the substrate, an explanation will be hereinafter given paying attention to the state in one pixel. In this example, on the TFT substrate, each pixel is divided into two regions on the right and left sides as shown in FIG. 2, and the alignment film is exposed to light in the direction set for each region. On the counter substrate, each pixel is divided into two regions on the upper and lower sides as shown in FIG. 3, and the alignment film is exposed to light in the direction set for each region. Arrows in FIGS. 2 and 3 each indicate the direction of light irradiation during exposure.

The tilt of the liquid crystal molecule will be hereinafter explained using a symbol. For example, in the state where the alignment direction is set leftward as shown by an arrow in FIG. 4 on the upper surface of the substrate and the liquid crystal molecule tilts accordingly, if this liquid crystal molecule is seen from above the substrate, the left end of the liquid crystal molecule in FIG. 4 is seen relatively closer to a viewer. Accordingly, this left end is shown as a head having an elliptical shape. Also, since the right end of the liquid crystal molecule in FIG. 4 is seen relatively further away from the viewer, this end is shown as a sharp tail. As a result, the state of the liquid crystal molecule corresponding to that in FIG. 4 is shown in the shape of a tadpole as in FIG. 5. The tilt direction of the liquid crystal molecule can be identified by the direction of the tadpole-shaped head.

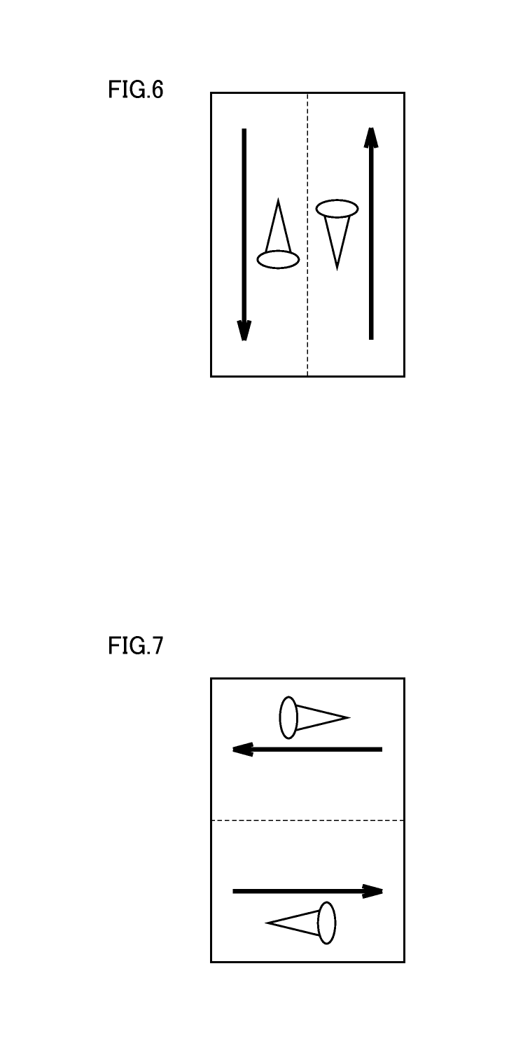

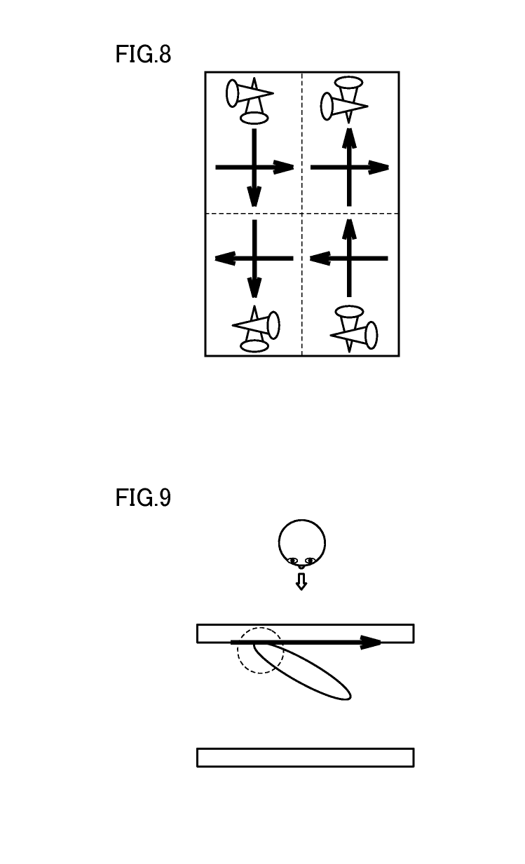

By exposing the alignment film to light from a fixed tilted direction, this alignment film is set in a fixed alignment direction. The alignment direction is opposite to the exposure direction. As shown in FIG. 2, as a result of exposing the TFT substrate to light, the alignment film on the surface of the TFT substrate is set in the alignment direction as shown in FIG. 6. As a result of exposing the counter substrate to light as shown in FIG. 3, the alignment film on the surface of the counter substrate is set in the alignment direction as shown in FIG. 7. The arrows in FIGS. 6 and 7 each indicate the alignment direction that has been set, and mean that the alignment film has a characteristic of causing the liquid crystal molecule near the alignment film to be tilted in this direction.

It is assumed that the counter substrate shown in FIG. 7 is turned over horizontally such that the positions of the right and left sides are reversed and is overlaid on the TFT substrate shown in FIG. 6, thereby holding the liquid crystal layer between the TFT substrate and the counter substrate. In this way, four domains are formed in one pixel as shown in FIG. 8. The arrow indicating the upward or downward direction in FIG. 8 shows an alignment direction of the alignment film formed on the upper surface of the TFT substrate. The arrow indicating the right or left direction in FIG. 8 shows an alignment direction of the alignment film formed on the lower surface of the counter substrate. The liquid crystal molecule that is tilted by the alignment film on the lower surface of the counter substrate is seen from the viewer through the counter substrate as shown in FIG. 9. Since the end of the liquid crystal molecule on the counter substrate side is relatively closer to the viewer, this end is shown as a head having a tadpole shape.

FIG. 8 shows that two tadpole shapes each indicating a liquid crystal molecule overlap each other in each domain, in which the tadpole shape located on the front surface side of the plane of FIG. 8 indicates the tilt direction of the liquid crystal molecule near the counter substrate while the tadpole shape located behind the above-mentioned liquid crystal molecule indicates the tilt direction of the liquid crystal molecule near the TFT substrate. In each domain, the tilt direction of the liquid crystal molecule near the TFT substrate and the tilt direction of the liquid crystal molecule near the counter substrate cross each other at right angles.

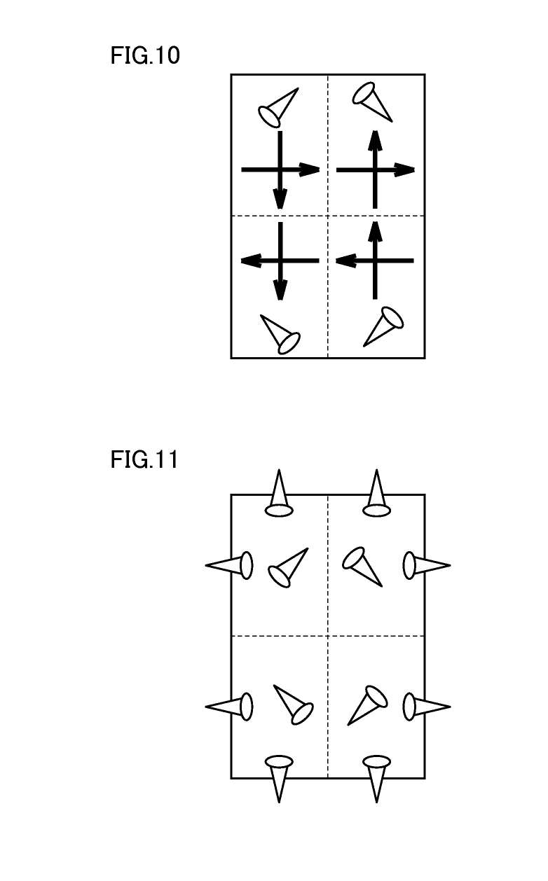

In the center area of the liquid crystal layer in the thickness direction, the liquid crystal molecule is tilted in the direction obtained by combining two tilt directions shown in FIG. 8, and therefore, the tilt direction of the liquid crystal molecule in the center area in the thickness direction in each domain is as shown in FIG. 10 When a voltage is applied, an oblique electric field is generated near the outline of the pixel electrode provided in the TFT substrate, which is as shown in FIG. 11. In other words, the liquid crystal molecule located near the outline of the pixel electrode tends to tilt so as to be perpendicular to the outline due to the influence of the oblique electric field. FIG. 11 shows tilted liquid crystal molecules on the outline of the pixel electrode.

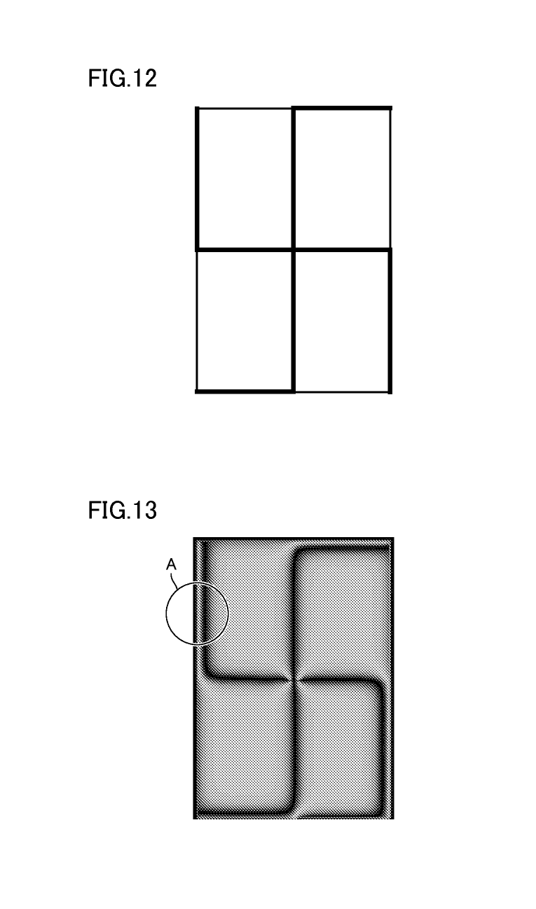

The side of the outline of each domain shown in FIG. 11 that also serves as an outline of the pixel will be referred to as a “domain side”. One pixel can be assumed to have eight domain sides. Each side of the pixel is formed of two domain sides. On the domain side in which the heads of the symbols of the liquid crystal molecules face each other, the direction of each liquid crystal molecule is disrupted, thereby producing a dark line. Furthermore, also in the portion where domains are adjacent to each other, the tilt directions of the liquid crystal molecules differ by 90°, which leads to formation of a dark line. Consequently, as shown in FIG. 12, dark lines appear in the boundary between the domains and in four domain sides on the outline of the pixel. As one entire pixel, a dark line appears in the shape of a hooked cross (swastika). FIG. 13 shows a simulation result about the transmissive state performed for confirming the situation where a dark line appears.

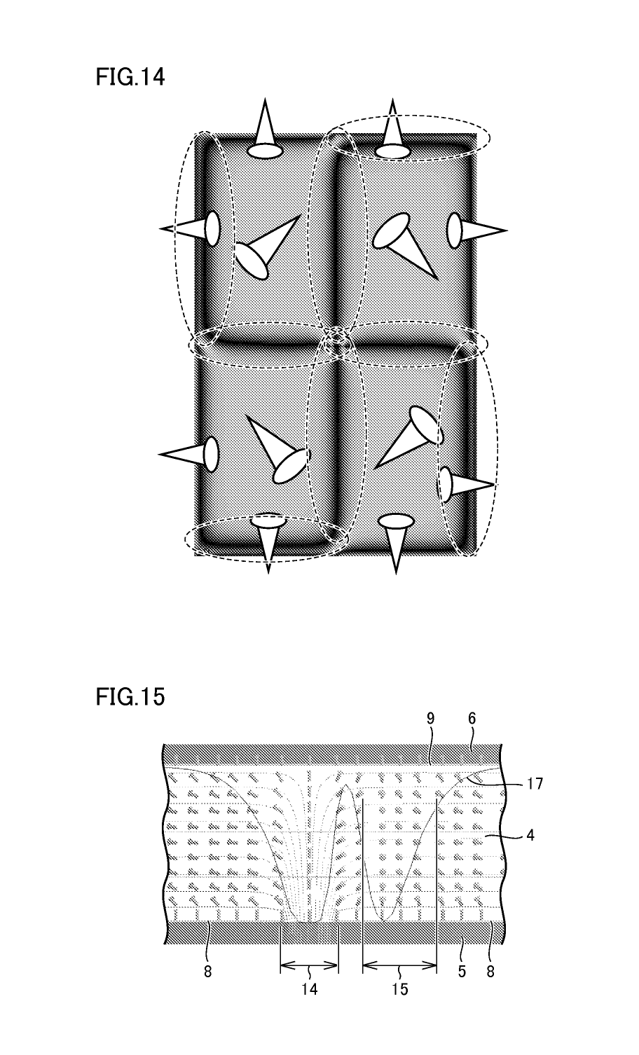

FIG. 14 shows that each symbol showing a liquid crystal molecule is overlapped with the simulation result about appearance of a dark line. In FIG. 14, a dark line appears in each section surrounded by a dashed-line ellipse.

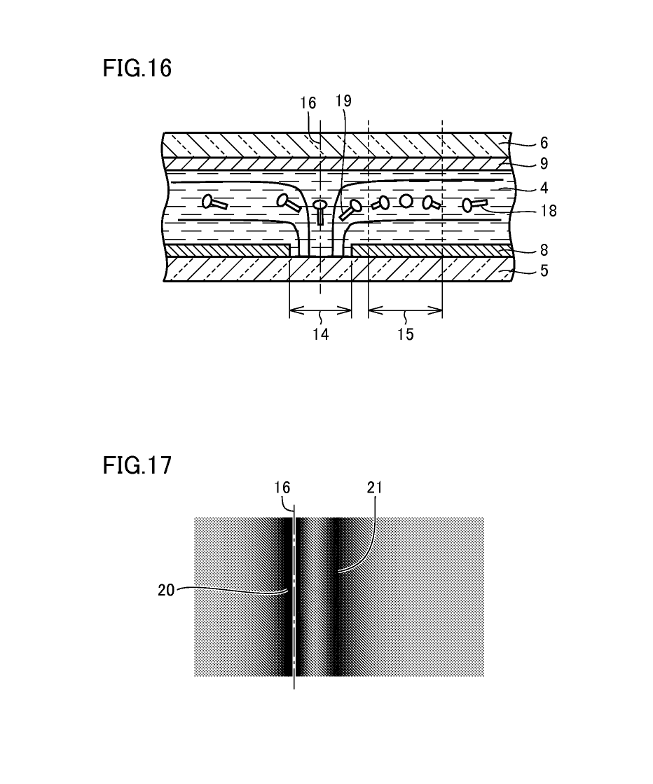

FIG. 15 shows a result of the inventors' examination for the behavior of each liquid crystal molecule in a liquid crystal layer 4 by means of simulation. A pixel electrode 8 is formed on the upper surface of a TFT substrate 5, and a counter electrode 9 is formed on the lower surface of a counter substrate 6. TFT substrate 5 and counter substrate 6 are arranged to face each other so as to sandwich liquid crystal layer 4 therebetween. FIG. 15 shows an area near a gap 14 between pixel electrodes 8. A number of pin-shaped graphical symbols shown in liquid crystal layer 4 each indicate the posture of the liquid crystal molecule in each portion. It is to be noted that the tilt may be shown exaggeratingly for the purpose of making it easy to understand the direction in which the liquid crystal molecule tilts. A curve 17 shown in liquid crystal layer 4 is a plot of the transmittance in the relevant portion in liquid crystal layer 4. As shown in FIG. 15, in addition to a decrease in the transmittance in gap 14, it is found that the transmittance is locally decreased also in a region 15 that is located at some distance from gap 14. This region 15 corresponds to a portion shown as a thick dark line in a portion A in FIG. 13. FIG. 16 shows a simplified version of the simulation result in FIG. 15. In the position within pixel electrode 8 located at a distance from the end of pixel electrode 8, liquid crystal molecule 18 tilts in the direction that is regarded as correct (which will be hereinafter referred to as a “correct direction”). As shown by a tadpole shape in FIG. 10, the correct direction extends at an angle of 45° with respect to the outer side of pixel electrode 8 as seen in a plan view. As shown in FIGS. 15 and 16, electric force lines are concentrated in gap 14 between pixel electrodes 8 so as to pass through gap 14, which exerts an influence on each liquid crystal molecule within a region onto which gap 14 is projected. For example, liquid crystal molecule 19 tilts in the direction almost opposite to the correct direction (which will be hereinafter referred to as an “opposite direction”). In region 15 resulting in a dark line, the direction of each liquid crystal molecule is abruptly changed from the opposite direction to the correct direction in a narrow section. It is considered that the dark line is caused by such an abrupt change in the direction of the liquid crystal molecule. FIG. 17 shows a simulation result about the transmissive state in this portion. The centerline of the gap between pixel electrodes 8 is defined as an intermediate line 16. A dark line 20 appears along intermediate line 16 while one more dark line 21 appears on the right side of dark line 20. Dark line 21 in FIG. 17 corresponds to region 15 in each of FIGS. 15 and 16. In FIG. 17, dark line 20 and dark line 21 can be collectively regarded as one strip-shaped dark line.

Having focused attention on the fact that a dark line appears based on the above-described principles, the inventors achieved the present invention for the purpose of suppressing appearance of such a dark line.

### First Embodiment

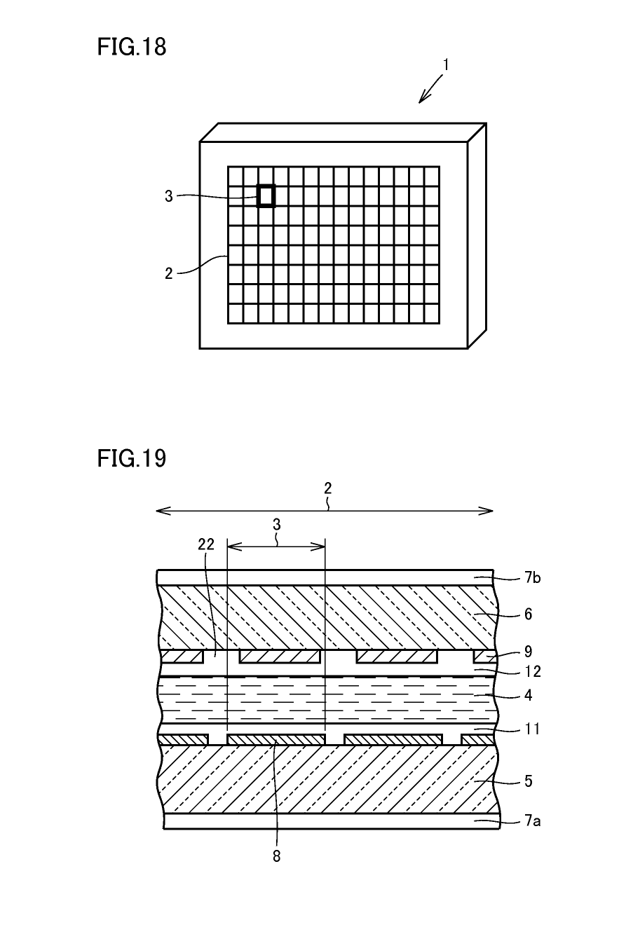

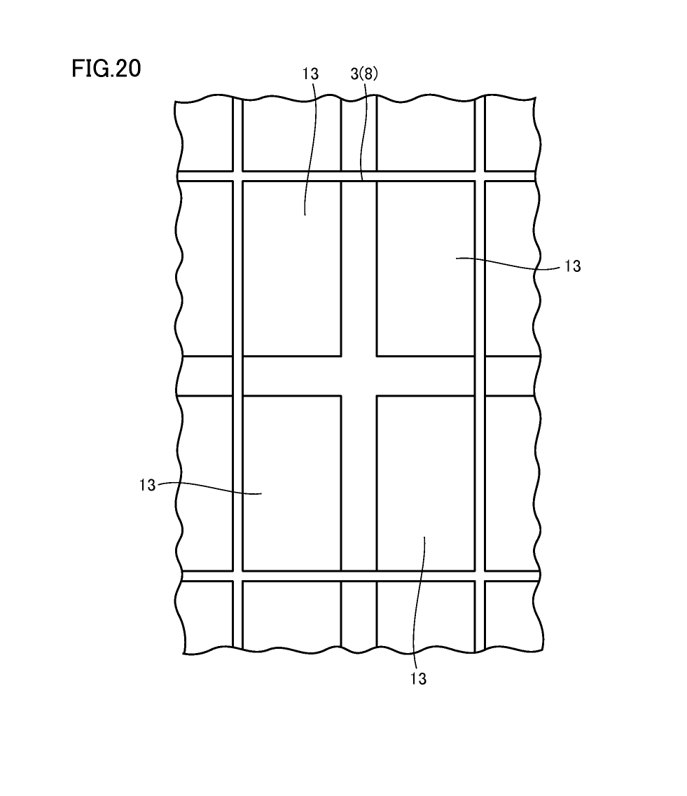

Referring to FIGS. 18 to 20, a liquid crystal display device in the first embodiment based on the present invention will be hereinafter described. As shown in FIG. 18, a liquid crystal display device 1 in the present embodiment has a display region 2 including a plurality of pixels 3. As shown in FIG. 19, liquid crystal display device 1 includes a liquid crystal layer 4 extending at least in display region 2; a TFT substrate 5 and a counter substrate 6 as the first substrate and the second substrate, respectively, that are affixed to each other so as to sandwich liquid crystal layer 4; and a pair of polarization plates 7a and 7b arranged so as to sandwich the first and second substrates. TFT substrate 5 serving as the first substrate is provided with a pixel electrode 8 corresponding to each of the plurality of pixels 3. Counter substrate 6 serving as the second substrate is provided with a counter electrode 9 so as to face pixel electrode 8. A first alignment film 11 is disposed on the surface of pixel electrode 8 that faces liquid crystal layer 4. A second alignment film 12 is disposed on the surface of counter electrode 9 that faces liquid crystal layer 4. In FIG. 19, the structures such as a TFT, an interconnection and a contact hole are not shown for convenience of explanation. As shown in FIG. 20, pixel 3 includes a plurality of domains 13 having different combinations of alignment directions of the first and second alignment films. As shown in FIG. 19, a slit 22 is provided in counter electrode 9 at least in a portion of the region corresponding to the boundary between adjacent pixels 3 among the plurality of pixels.

In the present embodiment, one pixel 3 includes four domains 13 as illustrated in FIG. 20. Pixel electrode 8 and counter electrode 9 may be formed of an ITO (indium Tin Oxide).

Counter substrate 6 may be a substrate in which a color filter is formed.

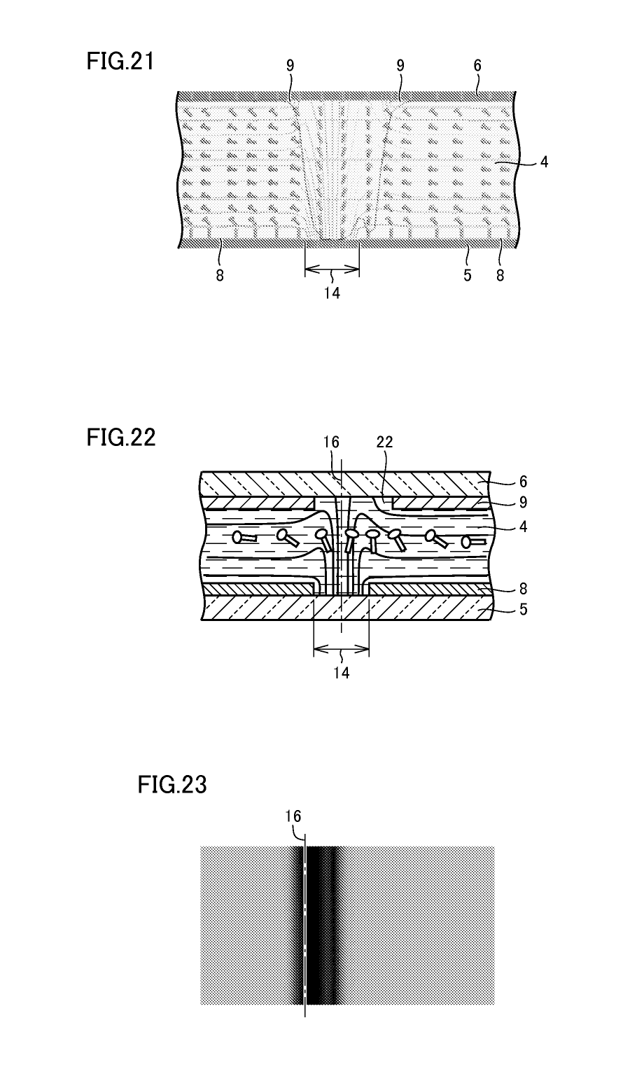

In the present embodiment, slit 22 is provided in counter electrode 9 as described above, so that the width of the dark line appearing near a part of the boundary between the pixels can be narrowed. In order to confirm this effect, the present inventors have carried out a simulation. The result is shown in FIG. 21. FIG. 22 shows a simplified version of the simulation result in FIG. 21. FIG. 23 shows the state of the dark line obtained in the liquid crystal display device in the present embodiment.

In the present embodiment, counter electrode 9 is provided with slit 22, which allows part of the electric force lines to pass through slit 22 on the counter substrate 9 side. Since each liquid crystal molecule tilts along the electric force line, the so-called orientation loss of the liquid crystal molecule is decreased. Consequently, as shown in FIG. 23, dark lines are combined into one line, and the total width of the dark lines appearing near the boundary between the pixels are narrowed. Although the dark line does not completely disappear in FIG. 23, the width of this dark line is apparently narrower than that shown in FIG. 17. Accordingly, it can be said that the effect of narrowing the width of the dark line can be achieved.

Slit 22 in counter electrode 9 is not necessarily identical in width to gap 14 in pixel electrode 8. As shown in FIG. 22, slit 22 may be wider than gap 14. The centerline of slit 22 does not necessarily coincide with intermediate line 16 of gap 14. Slit 22 may be located closer to one of the pixels. As shown in FIG. 17, a dark line originally appears in the position overlapping with the pixel on the right side. In the present embodiment, however, as shown in FIG. 22, slit 22 is located relatively closer to the pixel on the side where a dark line originally appears.

By adjusting the amount of the slit overlapping with the area where a dark line originally appears in this way, the degree of the liquid crystal molecule oriented in the opposite direction can be reduced. Consequently, the position where a dark line appears can be brought toward gap 14 between pixel electrodes 8, and the width of the appeared dark line can also be narrowed. As shown in FIG. 17, the width of the dark line protruding from intermediate line 16 toward the left is originally smaller than the width of the dark line protruding from intermediate line 16 toward the right. As shown in the present embodiment, slit 22 is provided in counter electrode 9, thereby limiting distribution of the electric force lines in the left-side pixel, with the result that the transmittance curve becomes steep as shown in FIG. 21. When comparing FIG. 21 with FIG. 15, it is found that the transmittance curves in the left-side pixel are different. When comparing FIG. 23 with FIG. 17, it is found that both sides of the dark line in the width direction are obscure in FIG. 17, whereas the outlines of both sides of the dark line in the width direction are relatively clear in FIG. 23.

In addition, it is preferable that slit 22 is provided in a section of the boundary between adjacent pixels where a dark line appears when no slit is provided in counter electrode 9. This is because such a configuration can achieve a particularly significant effect of reducing the width of the appeared dark line.

More precisely, it is preferable that, among the sides corresponding to the outer sides of each of the plurality of domains 13 and also corresponding to the outer sides of each of the plurality of pixels 3, that is, the domain sides, slit 22 is provided on the side to which the end of the liquid crystal molecule in liquid crystal layer 4 close to counter electrode 9 in the longitudinal direction is directed when the liquid crystal molecule is tilted in the center portion in each of the plurality of domains 13 by applying a voltage between pixel electrode 8 and counter electrode 9. This is because a relatively thick dark line tends to appear on the above-described side based on the principles, and a slit is provided on this side, thereby achieving a particularly significant effect of narrowing the width of the appeared dark line.

(Conditions for Simulation of Transmissive State)

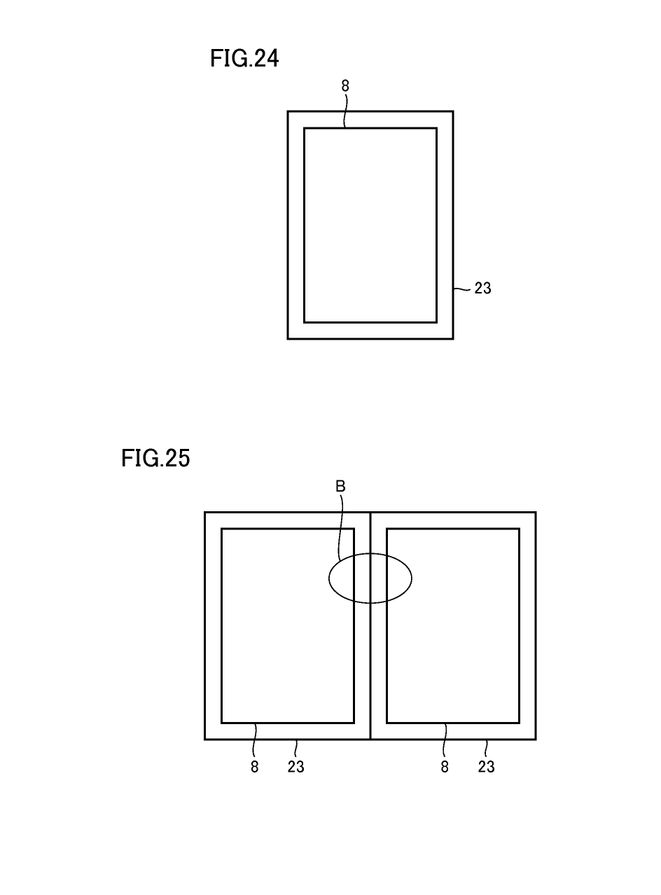

In the simulation of the transmissive state shown in FIG. 13, assuming that a rectangular plane region 23 having a length of 230.75 μm and a width of 153.75 μm is provided as shown in FIG. 24 as a region corresponding to one pixel, pixel electrode 8 is disposed inside this plane region 23 at a distance of 3 μm on each of the upper, lower, right and left sides. Therefore, the width of gap 14 between pixel electrodes 8 is 6 μm. The alignment direction of the alignment film in each substrate is as indicated by an arrow in FIG. 10 in the state where two substrates are stacked. In other words, the counter substrate has an alignment film divided into two upper and lower regions while the TFT substrate has an alignment film divided into two right and left regions. These substrates are stacked to form four domains as shown in FIG. 10. Therefore, the tilt directions of the liquid crystal molecules in the center areas in the thickness direction within the domains are as shown by four tadpole shapes, respectively, in FIG. 10. In this simulation, the pre-tilt angle of the liquid crystal molecule is 88.2° in each of TFT substrate 5 and counter substrate 6.

(Conditions for Simulation of Behavior of Liquid Crystal Molecule)

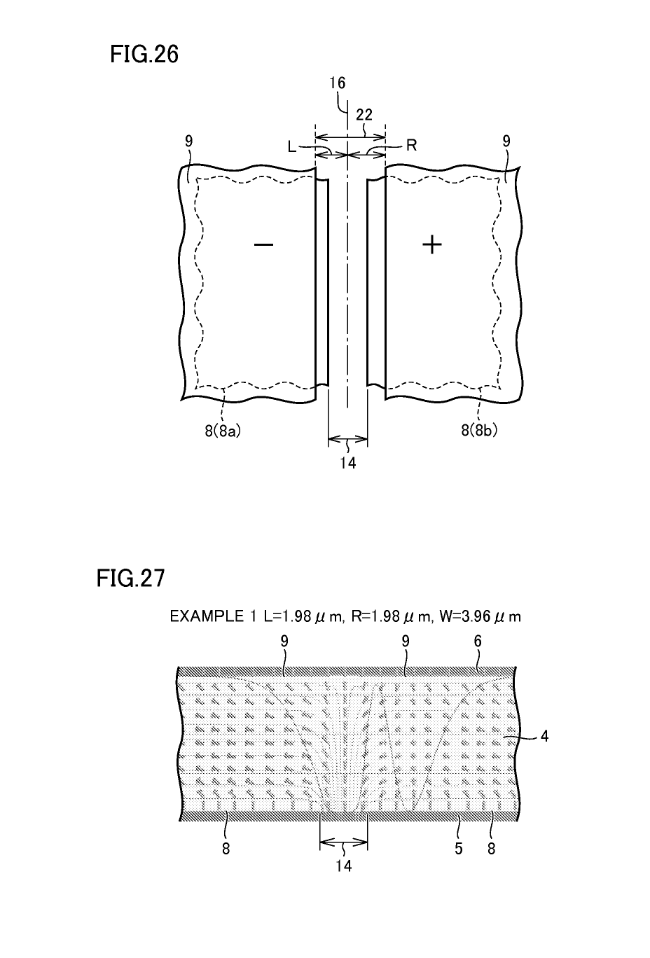

FIG. 25 shows that two pixels each shown in FIG. 24 are arranged side by side. As to the simulation of the behavior of the liquid crystal molecule shown in each of FIGS. 15 and 21, it is assumed to employ the structure shown in FIG. 26 that corresponds to a portion B shown in an enlarged view in FIG. 25. In this simulation, it is assumed to employ the dot inversion driving scheme commonly used for a currently mass-produced liquid crystal display panel, to apply electric potentials opposite to each other to pixel electrodes 8a and 8b adjacent to each other. Symbols of “−” and “+” shown in FIG. 26 indicate electric potentials applied to pixel electrodes 8a and 8b, respectively.

(Experiment)

The experiment was performed using several patterns of positional relationships between slit 22 of counter electrode 9 and intermediate line 16 of gap 14. As shown in FIG. 26, slit 22 is disposed asymmetrically with respect to intermediate line 16, in which the width of a portion of slit 22 located on the left side with respect to intermediate line 16 is indicated as L and the width of a portion of slit 22 located on the right side with respect to intermediate line 16 is indicated as R. The entire width of slit 22 is indicated as W. Accordingly, the condition of L+R=W is always satisfied. Lengths of L, R and W were changed in several ways while the width of gap 14 was set at a fixed value.

FIGS. 15 and 17 each show the simulation result in the case where the present invention is not implemented, and will be hereinafter referred to as a “Comparative Example”. In order to understand the degree of the effect of each example described below, the simulation result about the behavior of the liquid crystal molecule should be compared with that in FIG. 15, and the simulation result about the transmissive state should be compared with that in FIG. 17.

### EXAMPLE 1

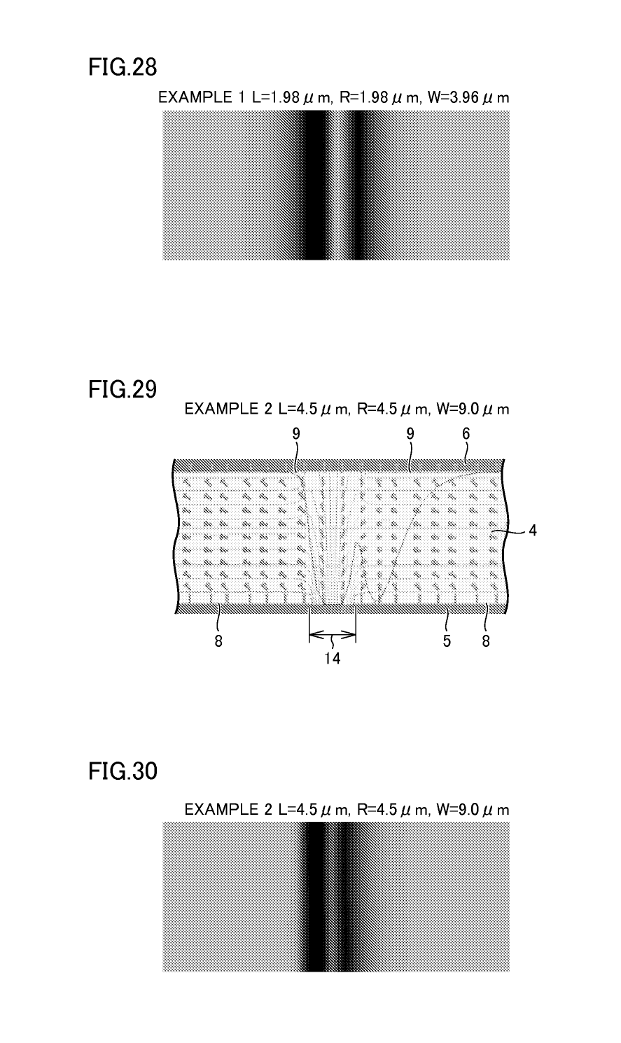

First, as Example 1 based on the present invention, FIGS. 27 and 28 each show the simulation result in the case where a slit width W is set at 3.96 μm by setting both of L and R at 1.98 μm. In Example 1, although slightly improved as compared with Comparative Example, slit 22 in counter electrode 9 exerted less influence on the electric field, and also, the behavior of each liquid crystal molecule and the transmissive state could be only slightly improved as compared with those in Comparative Example.

### EXAMPLE 2

As Example 2 based on the present invention, FIGS. 29 and 30 each show the simulation result in the case where slit width W is set at 9.0 μm by setting both of L and R at 4.5 μm. In Example 2, due to the influence of slit 22 of counter electrode 9, the electric force lines are changed and the orientation of each liquid crystal molecule is changed. The direction of each electric force line at the end of the left-side pixel electrode 8 is changed upward, thereby strengthening the force of restraining orientation of each liquid crystal molecule in the left-side pixel electrode 8. This leads to an abrupt change in the posture of each liquid crystal molecule that is gradually changed in Comparative Example. Consequently, the transmittance near the end of the left-side pixel electrode 8 is significantly increased as compared with Comparative Example.

### EXAMPLE 3

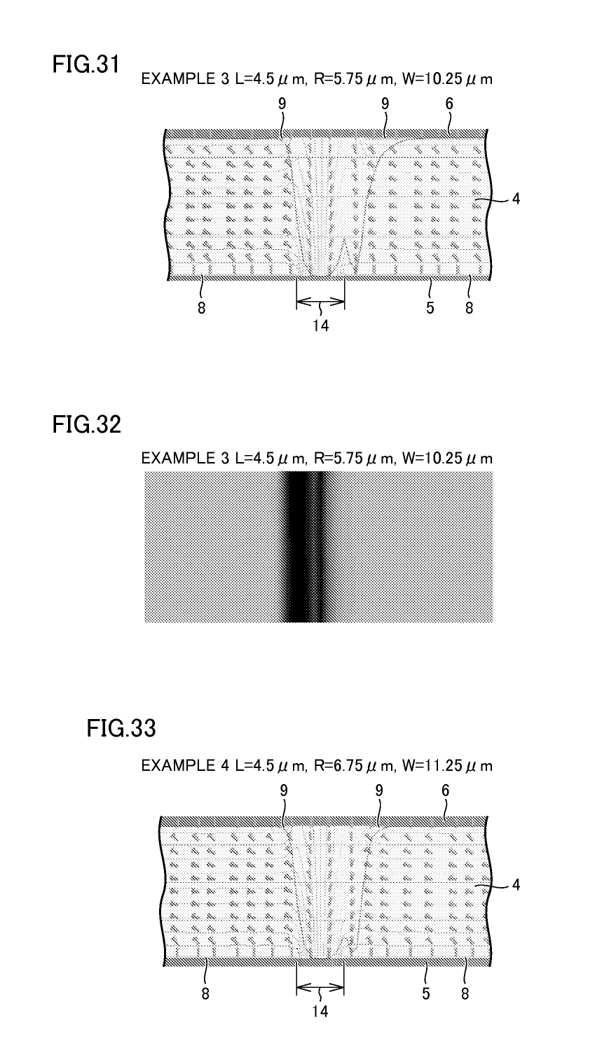

As Example 3 based on the present invention, FIGS. 31 and 32 each show the simulation result in the case where slit width W is set at 10.25 μm by setting L and R at 4.5 μm and 5.75 μm, respectively.

### EXAMPLE 4

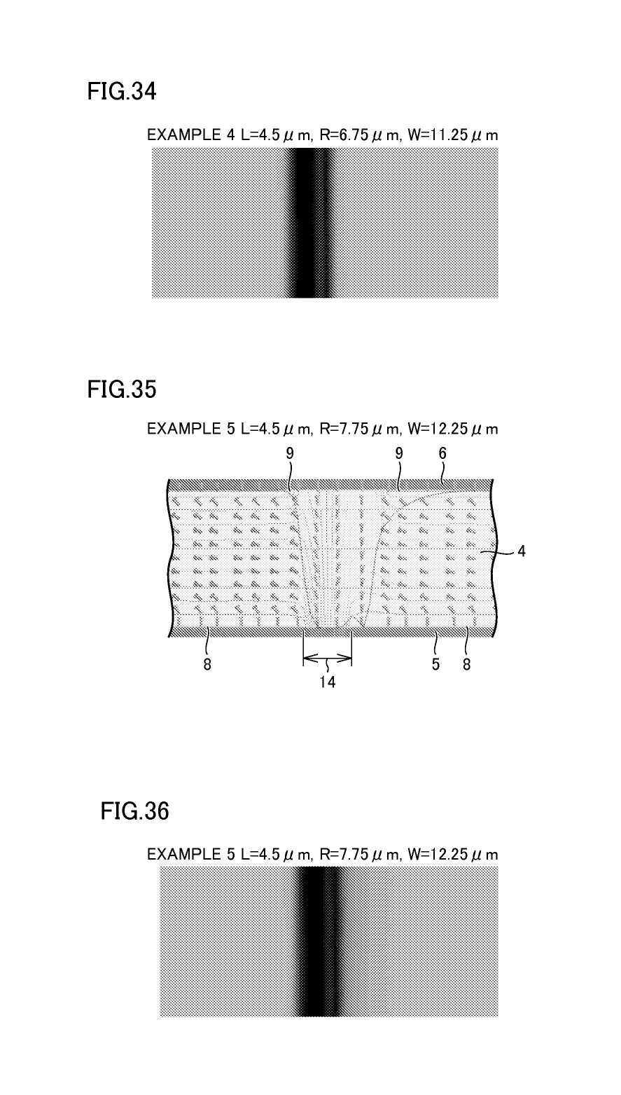

As Example 4 based on the present invention, FIGS. 33 and 34 each show the simulation result in the case where slit width W is set at 11.25 μm by setting L and R at 4.5 μm and 6.75 μm, respectively.

In Examples 3 and 4, only R is changed while L is set at a fixed value. Referring to FIGS. 31 and 33, the greater the R is, the more the electric force lines pass through toward counter substrate 6 and the less the liquid crystal molecules are oriented in the opposite direction. This results in a decrease in the area where the liquid crystal molecules continuously rotate from the opposite direction to the correct direction, and also, the dark line appearing at the position displaced from the end of the right-side pixel electrode 8 slightly toward the right is shifted toward the left, that is, toward the end of pixel electrode 8. Furthermore, the direction of the electric force line is changed upward, which causes strengthened force of restraining orientation of each liquid crystal molecule also in the right-side pixel, thereby increasing the transmittance also in the right-side pixel.

### EXAMPLE 5

As Example 5, FIGS. 35 and 36 each show the simulation result in the case where slit width W is set at 12.25 μm by setting L and R at 4.5 μm and 7.75 μm, respectively. In this Example, R is increased by 1 μm from that in Example 4. In this case, since a break of the electric force line occurs inside the right-side pixel, the restraining force of the electric force line exerts an influence on a portion of the right-side pixel electrode 8 that is located at a distance from the left end of this pixel electrode 8 to the right. In other words, the orientation direction of each liquid crystal molecule is displaced. Accordingly, the transmittance curve within the right-side pixel is gently sloped and the transmittance is decreased.

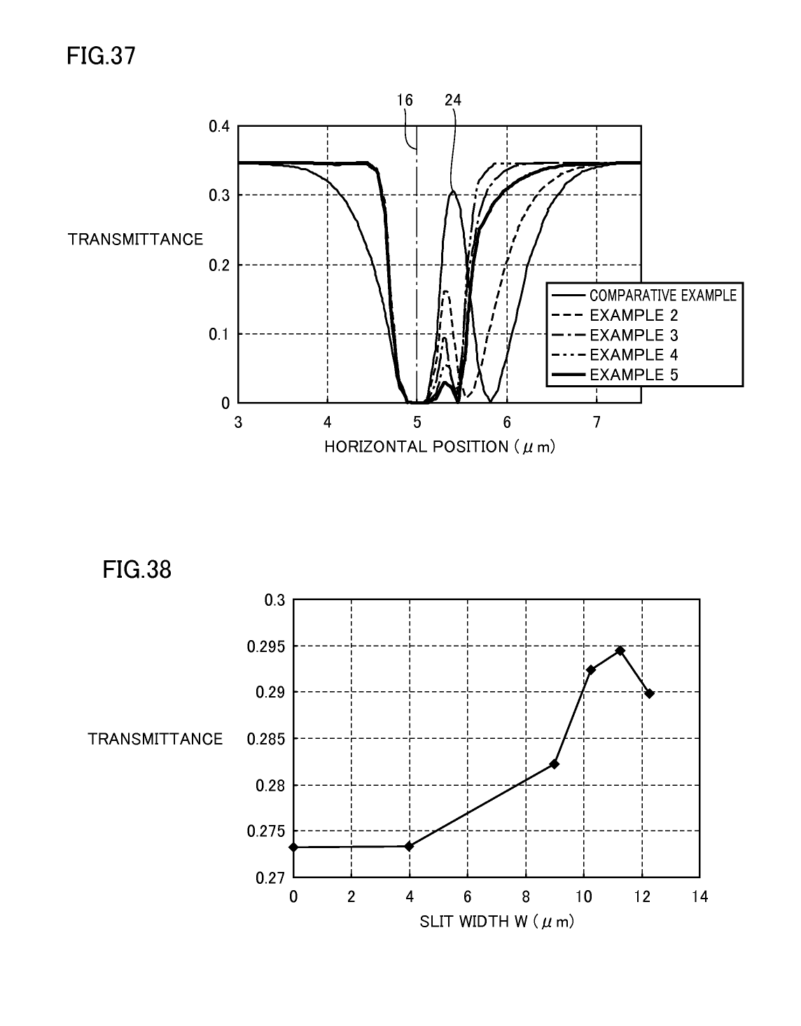

The transmittance curves in Comparative Example and Examples 2 to 5 overlap each other, which leads to a graph as shown in FIG. 37. Example 1 cannot achieve a significant effect, and therefore, is not shown in FIG. 37. In Comparative Example, a total of two dark lines appear, including a dark line overlapping with intermediate line 16 of gap 14 between pixel electrodes 8 and a nearby dark line located at a distance from the above dark line within the pixel. Also, a peak 24 of the transmittance occurs between these two dark lines. It is found that as slit width W is larger gradually in the order of Example 2 to Example 5, the height of peak 24 is lower and the edge of the saturation region of the transmittance in the right-side pixel is more shifted toward the left end of the pixel electrode. It is considered that this is because slit 22 provided in counter electrode 9 serves to suppress the degree of orientation of each liquid crystal molecule in the opposite direction at the end of pixel electrode 8.

In Example 5, the height of peak 24 of the transmittance is the lowest, and two dark lines come close to each other and become almost indistinguishable from each other. Consequently, these two dark lines appear to be one dark line. In Example 5, while the height of peak 24 is the lowest, a shoulder part of the saturation region of the transmittance in the right-side pixel is gently sloped as compared with Example 4. Accordingly, the overall transmittance in Example 5 is lower than that in Example 4.

FIG. 38 shows a graph of the change in the overall transmittance when slit width W is changed in Examples 1 to 5. In Comparative Example, slit width W is assumed to be zero and incorporated into the graph. FIG. 38 shows that the transmittance is the largest in the case of Example 4, that is, in the case where slit width W is 11.25 μm. Therefore, the experimental result shows that the maximum effect of the present invention can be achieved when slit width W is 11.25 μm.

This optimum value may be changed when another parameters are changed. However, in the present invention, it is more preferable to provide the slit in the counter electrode so as to displace the centerline from the intermediate line of the gap between the pixel electrodes than to align the centerline with the intermediate line. It is to be noted that the centerline should be displaced toward a dark line that appears when a slit is not provided. This will be explained in another way as below. In the liquid crystal display device in the present embodiment, it is preferable that an intermediate line is defined as passing through the center of the gap between the pixel electrodes, and, in a section where a strip-shaped dark line appears so as to overlap in parallel with the intermediate line based on a line as a centerline displaced from the intermediate line to the first side in parallel to the intermediate line when the slit is not provided in the counter electrode, the slit is provided to cover the intermediate line such that the width protruding from the intermediate line toward the first side is greater than the width protruding toward the second side opposite to the first side. The “strip-shaped dark line” used herein may be such a line that, even in the case of a plurality of separated dark lines in a strict sense, these dark lines appear in positions close to each other and thereby can be regarded as almost one dark line in their entirety, as in the example shown in FIG. 17. Referring to the example in FIG. 26, the “first side” is on the right side while the “second side” is on the left side. It is preferable that the slit in the counter electrode is displaced to one side in this way. By employing the above-described configuration, the area where electric force lines pass through the slit can be greatly overlapped with the area where a dark line appears, so that appearance of the dark line can be efficiently suppressed.

As shown in FIG. 26, it is preferable that the width of the slit provided in the counter electrode is greater than the width of the gap between the pixel electrodes. This is because the above-described configuration can fully accommodate a dark line having a width greater than the width of the gap between the pixel electrodes.

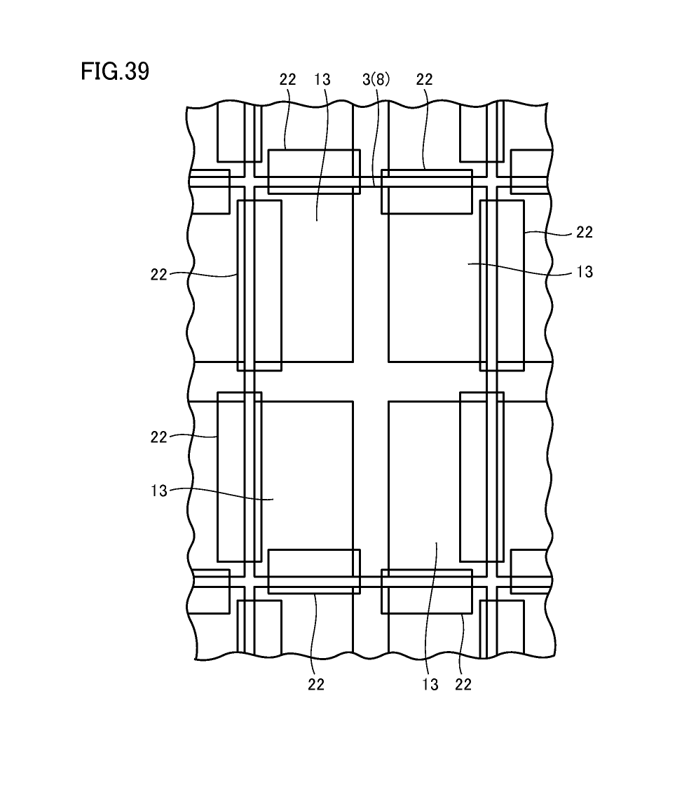

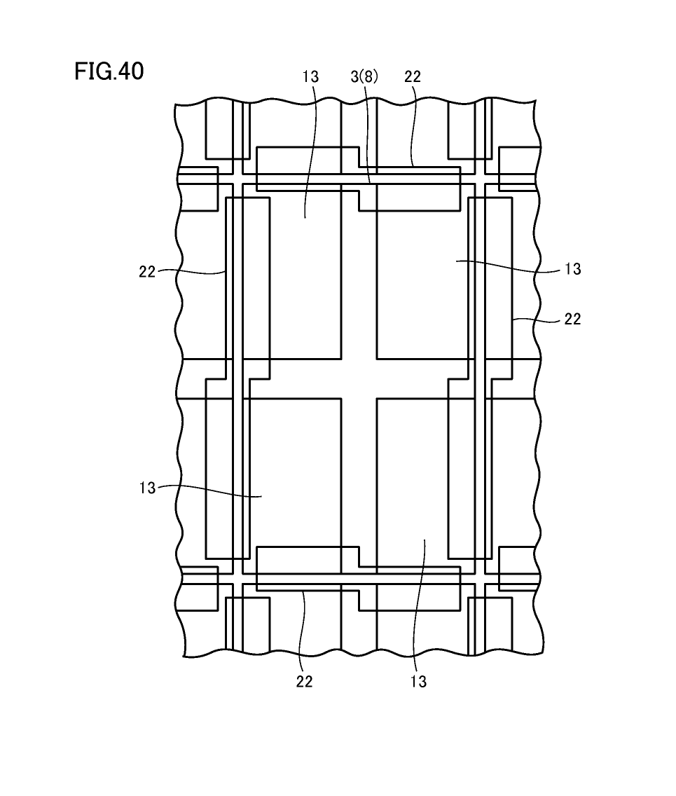

In addition, slit 22 in counter electrode 9 does not have to be provided throughout the region corresponding to the boundary between pixels 3 adjacent to each other, but only has to be partially provided. When counter electrode 9 is configured to be completely separated by slit 22, it becomes necessary to provide the configuration for electrically connecting these separated counter electrodes 9. Accordingly, it is preferable that slit 22 is intermittently provided so as not to completely separate counter electrode 9. As seen in a plan view, for example, the configuration shown in each of FIGS. 39 and 40 may be conceivable.

In FIG. 39, one slit 22 is provided for each domain side. In FIG. 40, one slit 22 is provided for each side of a pixel. Two domain sides are arranged along one side of the pixel. Since the centerline of slit 22 is differently positioned in these two domain sides, slit 22 is shaped such that its centerline is displaced in the middle.

In addition, although it has been explained in the above that the alignment film is set in a specific alignment direction by exposure to light, the method of setting the alignment direction for the alignment film may be those other than exposure to light.

The above-described embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The present invention can be applied to a liquid crystal display device.

### REFERENCE SIGNS LIST

1 liquid crystal display device, 2 display region, 3 pixel, 4 liquid crystal layer, 5 TFT substrate, 6 counter substrate, 7a, 7b polarization plate, 8 pixel electrode, 9 counter electrode, 11 first alignment film, 12 second alignment film, 13 domain, 14 gap, 15 region, 16 intermediate line, 17 curve (indicating transmittance), 18 liquid crystal molecule (in the right posture), 19 liquid crystal molecule (tilted in the almost opposite direction), 20, 21 dark line, 22 slit (provided in a counter electrode), 23 plane region, 24 peak.

1. A liquid crystal display device having a display region including a plurality of pixels, said liquid crystal display device comprising:
a liquid crystal layer extending at least in said display region;
first and second substrates affixed to each other so as to sandwich said liquid crystal layer; and
a pair of polarization plates disposed so as to sandwich said first and second substrates,
said first substrate being provided with a pixel electrode corresponding to each of said plurality of pixels,
said second substrate being provided with a counter electrode so as to face said pixel electrode,
a first alignment film being disposed on a surface of said pixel electrode, said surface facing said liquid crystal layer,
a second alignment film being disposed on a surface of said counter electrode, said surface facing said liquid crystal layer,
said pixels each including a plurality of domains having different combinations of alignment directions of said first and second alignment films, and
a slit being provided in said counter electrode at least in a part of a region corresponding to a boundary between pixels adjacent to each other among said plurality of pixels.

2. The liquid crystal display device according to claim 1, wherein said slit is provided in a section where a dark line appears when said slit is not provided in said counter electrode in the boundary between said pixels adjacent to each other.

3. The liquid crystal display device according to claim 1, wherein, among sides corresponding to outer sides of each of said plurality of domains and corresponding to outer sides of each of said plurality of pixels, said slit is provided on a side to which an end of a liquid crystal molecule in said liquid crystal layer close to said counter electrode in a longitudinal direction is directed when said liquid crystal molecule is tilted in a center portion in each of said plurality of domains by applying a voltage between said pixel electrode and said counter electrode.

4. The liquid crystal display device according to claim 1, wherein an intermediate line is defined as passing through the center of a gap between said pixel electrodes, and, in a section where a strip-shaped dark line appears so as to overlap in parallel with said intermediate line based on a line as a centerline displaced from said intermediate line to a first side in parallel to said intermediate line when said slit is not provided in said counter electrode, said slit is provided to cover said intermediate line such that a width protruding from said intermediate line toward said first side is greater than a width protruding toward a second side opposite to said first side.

5. The liquid crystal display device according to claim 1, wherein said slit is greater in width than the gap between said pixel electrodes.
